(19) United States
(12) Patent Application Publication
(10) Pub. No.: US 2023/0316297 A1
(43) Pub. Date: Oct. 5, 2023

(54) SYSTEMS AND METHODS FOR PERSONALITY BASED ROUTING FOR DIGITAL CONTACTS

(71) Applicant: InContact Inc., Salt Lake City, UT (US)

(72) Inventor: Andrew HICKS, Salt Lake City, UT (US)

(73) Assignee: InContact Inc., Salt Lake City, UT (US)

(21) Appl. No.: 17/709,266

(22) Filed: Mar. 30, 2022

(51) Int. Cl. G06Q 30/00; G06Q 10/10

(52) U.S. Cl. CPC G06Q 30/016; G06Q 10/107

(57) ABSTRACT

Systems and methods for a computerized-method for personality based routing for digital contacts are provided. A digital contact can be received from a customer and the customer contact details including phone numbers, emails and/or social media handles can be pulled from a customer database and/or a customer contact details entry can be created. A personality profile can be determined based on the customer contact detail and one or more machine learned algorithms. A prioritized list of available agents can be determined from a plurality of agents based on the personality profile. The customer can be routed to the agent from the prioritized list of agents having the highest priority.

### FIELD OF THE INVENTION

The invention relates to automated call center routing systems. In particular, the invention relates to personality-based call center routing systems that can allow for digital contacts.

### BACKGROUND OF THE INVENTION

Current system systems for contact centers can route contacts to agents based on personality to, for example, increase desired behaviors for contact centers. For example, it can be desirable to increase a customer satisfaction score, up-sells and/or minimize contact handle time. Typically, current contact center systems use a customer's contact customer's Automatic Number Identification (e.g., telephone phone number) only to determine personality characteristic for routing a call. If a customer uses a contact method other than a telephone (e.g., chat window on a computer), the customer's personality may not be identifiable. Therefore, it can be desirable to have a contact center system that can allow for personality-based routing for digital contacts.

### SUMMARY OF THE INVENTION

One advantage of the invention can include call personality center routing that allows for analog and/or digital contacts. One advantage of the invention can involve obtaining a personality type for a customer and matching it to an agent to achieve a desired outcome for tenants. This can allow for quick adaption of personality-based routing to digital contacts and/or a more robust method for identifying a personality for customers based on multiple known social handles rather than just the ANI. One advantage of the invention can include expanding customer knowledge without performing upfront analysis on each customer before providing a personality match.

In one aspect, the invention involves a computerized-method for personality based routing for digital contacts. The computerized-method involves receiving, via a server, a digital contact from a customer. The computerized-method involves retrieving, via the server, customer contact details from a customer database based on the digital contact if the customer contact details exist, wherein the contact details include at least one of phone numbers, emails and social media handles. The computerized-method involves creating, via the server, a customer contact details entry to input to the customer database based on the digital contact if the customer contact details does not exist, and adding the digital contact details to the contact details. The computerized-method involves determining, via the server, a personality profile based on the customer contact details and one or more machine learned algorithms. The computerized-method involves determining, via the server, a prioritized list of available agents from a plurality of agents based on the personality profile. The computerized-method involves routing, via the server, the customer to the agent from the prioritized list of agents having a highest priority.

In some embodiments, the computerized-method also involves determining, via the server, which agents from the prioritized list of agents are currently engaged. In some embodiments, the computerized-method also involves removing, via the server, the currently engaged agents from the prioritized list of agents. In some embodiments, the digital contact is a messaging application.

In some embodiments, wherein a number of agents in the plurality of agents is configurable. In some embodiments, wherein each agent of the plurality of agents includes a past performance indicator for each of one or more personality types. In some embodiments, wherein determining the prioritized list of available agents further comprises matching the personality profile of the customer with the one or more personality types of the plurality of agents.

In another aspect, the invention includes a non-transitory computer program product comprising instruction which, when the program is executed cause the computer to receive a digital contact from a customer. The non-transitory computer program product comprises instructions which when executed cause the computer to retrieve customer contact details from a customer database based on the digital contact if the customer contact details exist, wherein the contact details include at least one of phone numbers, emails and social media handles. The non-transitory computer program product comprises instructions which when executed cause the computer to create a customer contact details entry to input to the customer database based on the digital contact if the customer contact details does not exist, and adding the digital contact details to the contact details. The non-transitory computer program product comprises instructions which when executed cause the computer to determine a personality profile based on the customer contact details and one or more machine learned algorithms. The non-transitory computer program product comprises instructions which when executed cause the computer to determine a prioritized list of available agents from a plurality of agents based on the personality profile. The non-transitory computer program product comprises instructions which when executed cause the computer to route the customer to the agent from the prioritized list of agents having a highest priority.

In some embodiments, the non-transitory computer program product comprises instructions which when executed cause the computer to determine which agents from the prioritized list of agents are currently engaged and remove the currently engaged agents from the prioritized list of agents.

In some embodiments, the digital contact is a messaging application. In some embodiments, a number of agents in the plurality of agents is configurable. In some embodiments, each agent of the plurality of agents includes a past performance indicator for each of one or more personality types.

In some embodiments, determining the prioritized list of available agents further comprises matching the personality profile of the customer with the one or more personality types of the plurality of agents.

In another aspect, the invention includes a system for personality based routing for digital contacts. The system includes one or more processors configured to receive a digital contact from a customer. The one or more processor are configured to retrieve customer contact details from a customer database based on the digital contact if the customer contact details exist, wherein the contact details include at least one of phone numbers, emails and social media handles. The one or more processor are configured to create a customer contact details entry to input to the customer database based on the digital contact if the customer contact details does not exist, and adding the digital contact details to the contact details. The one or more processor are configured to determine a personality profile based on the customer contact details and one or more machine learned algorithms. The one or more processor are configured to determine a prioritized list of available agents from a plurality of agents based on the personality profile. The one or more processor are configured to route the customer to the agent from the prioritized list of agents having a highest priority.

In some embodiments, the one or more processors are further configured to determine which agents from the prioritized list of agents are currently engaged and remove the currently engaged agents from the prioritized list of agents. In some embodiments, the digital contact is a messaging application. In some embodiments, a number of agents in the plurality of agents is configurable.

In some embodiments, each agent of the plurality of agents includes a past performance indicator for each of one or more personality types. In some embodiments, determining the prioritized list of available agents further comprises matching the personality profile of the customer with the one or more personality types of the plurality of agents.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for personality-based routing for digital contacts, according to some embodiments of the invention.

FIG. 2 is a method for personality-based routing for digital contacts, according to some embodiments of the invention.

FIG. 3 shows a method for determining and/or updating customer contact details for personality based routing for digital contacts, according to some embodiments of the invention.

FIG. 4 shows a method for determining a list of agents ordered by priority to service a contact, according to some embodiments of the invention.

FIG. 5 is a screen shot showing an output screen of analytics of a call center, according to some embodiments of the invention.

FIG. 6 is a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

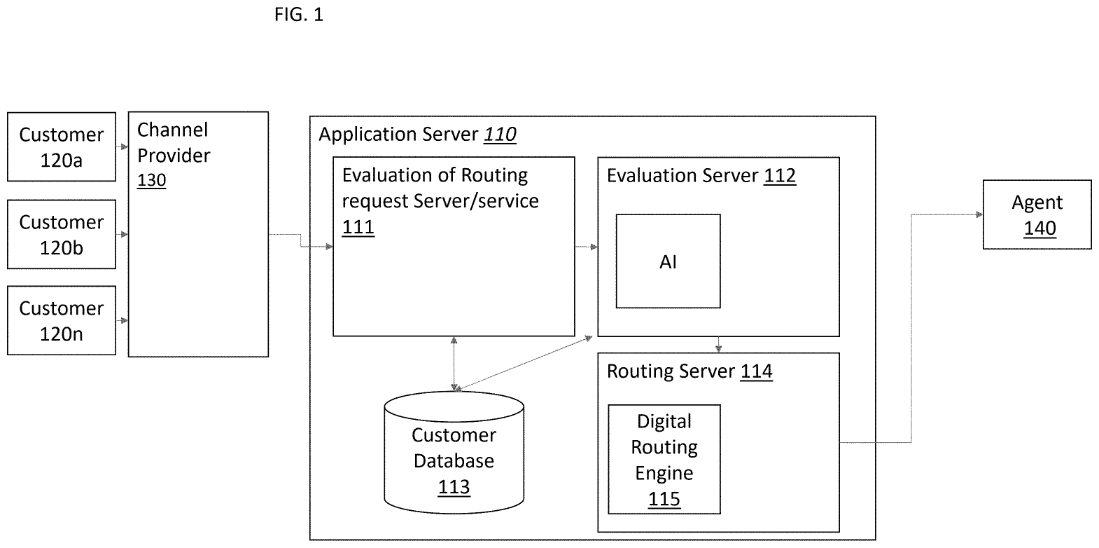

FIG. 1 is a block diagram of a system 100 for personality-based routing (e.g., routing based on a personality of customers and/or agents) for digital contacts, according to some embodiments of the invention. The system 100 can include an application server 110, a plurality of customers 120a, 120b, . . . 120n, generally 120, a channel provider 130, and/or an agent 140.

The plurality of customers 120 can communicate via the channel provider 130 to the application server 110, for example, send requests for service.

The channel provider 130 can be any system that a customer can contact a system that includes routing of agents (e.g., a call center). For example, channel providers 130 can include, Facebook™, Twitter™, WhatsApp™, Instagram™, Apple Business Chat™, YouTube™, Chat™, email, SMS, and/or other communication channel providers as are known in the art.

The evaluation server 112 can include machine learning to perform a lookup check for an inbound contact to see if there is a known match and/or personality type. In some embodiments, the inbound contact is evaluated for intent. The inbound message can be cross referenced with routing queues and/or the agents in the routing queues and a prioritized list of agents to service the contact can be built. There can be feedback loop into evaluation server 112 of agent messages where the agent performance in analyzed for future routing options as well as the transcript to provide updates to the customer profile database.

The application servicer 110 can include an evaluation of routing request server 111, an evaluation server 112, a customer database 113, and/or a routing server 114. The routing server 114 can include a digital routing engine 115.

The agent 140 can be any agent of a particular service. In some embodiments, there are multiple agents.

As is apparent to one of ordinary skill in the art, the application server 110 and its components can be implemented on one computing device or several computing device, in any configuration. In various embodiments, the communication between the system 100 is wireless over a wireless network (e.g., the internet or an intranet) and/or wired.

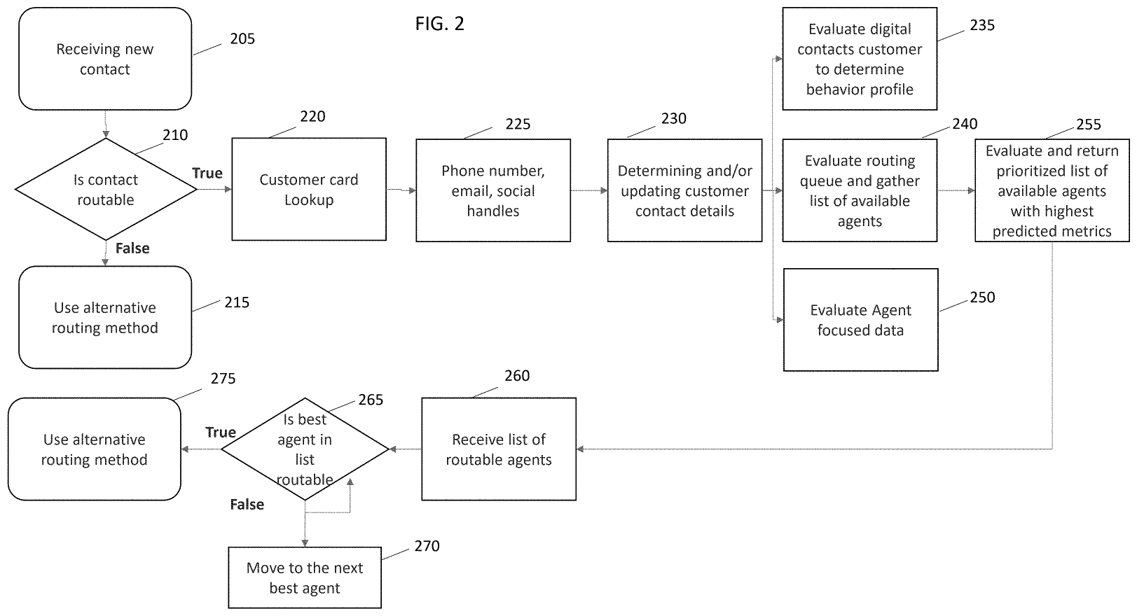

FIG. 2 is a method 200 for personality-based routing for digital contacts, according to some embodiments of the invention.

The method can involve receiving a new contact from a customer (e.g., via the application server 110, as shown above in FIG. 1) (Step 205). The contact can be an analog or digital contact. The analog contact can be through the telephone system. The digital contact can be through smartphones (e.g., digital voice, SMS, chat platforms and/or other communication apps as are known in the art), through social media and/or email.

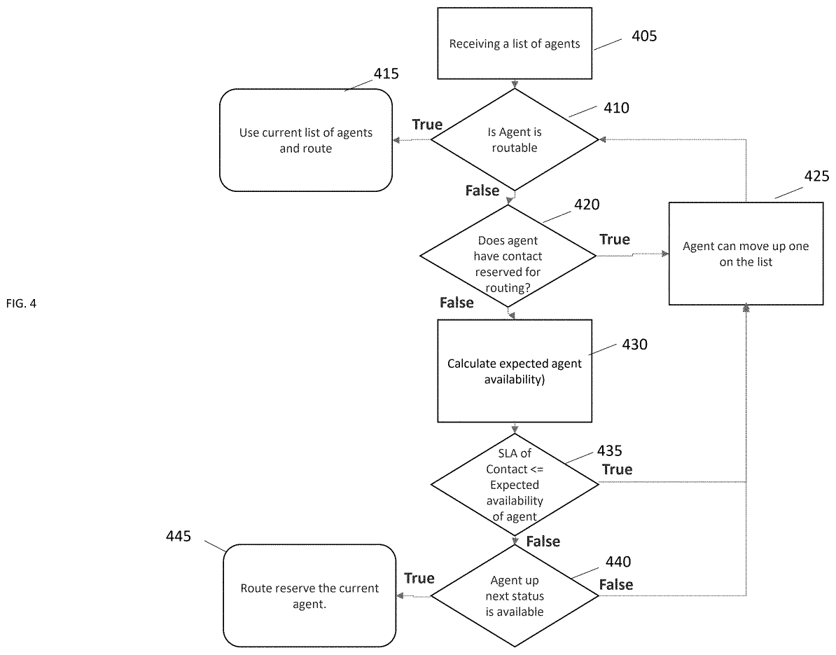

The method can also involve determining (e.g., by the evaluation of routing request server 111, as shown above in FIG. 1) if the contact is routable (Step 210). In some embodiment, the determination as to whether the contact is routable can be based on an agent's state. Whether an agent is routable can be determined as shown below in FIG. 4.

If the contact is not routable, then an alternative routing method (e.g., routing based on agent skill set) can be used (Step 215). In some embodiments, skill based routing can be used.

If the contact is routable, then the method can also involve looking up (e.g., by the evaluation server 112, as shown above in FIG. 1) customer contact details within a customer database (e.g., the customer database 113, as shown above in FIG. 1) (Step 220).

In some embodiments, the customer database lookup returns a JSON file. The JSON file can appear as shown below in Table 1:

TABLE 1

| | |
|---|---|
| a. | { |
| b. | “Customer_Handles”: [ |
| c. | { |
| d. | “id_Type”: “Phone”, |
| e. | “id”: “+18881234567”, |
| f. | }, |
| g. | { |
| h. | “id_Type”: “Phone”, |
| i. | “id”: “+18884657891”, |
| j. | }, |
| k. | { |
| l. | “id_Type”: “Social_Facebook”, |
| m. | “id”: “@FBacountname”, |
| n. | }, |
| o. | { |
| p. | “id_Type”: “Social_Twitter”, |
| q. | “id”: “@TWacountname”, |
| r. | }, |
| s. | { |
| t. | “id_Type”: “Email”, |
| u. | “id”: “name@domain.com”, |
| v. | }, |
| w. | { |
| x. | “id_Type”: “Email”, |
| y. | “id”: “name@domain2.com”, |
| z. | }, |
| aa. | |
| bb. | ] |
| cc. | } |

The customer contact details can include at least one of a phone number, email address, and social media handle (Step 225).

The method can also involve determining and/or updating (e.g., by the evaluation engine 112, as shown above in FIG. 1) customer contact details (Step 230). For a contact that includes customer contact details that are not within the customer database, the customer contact details can be added to the customer contact that already exists for a given customer or a new customer contact can be created if the customer is completely absent from the customer database.

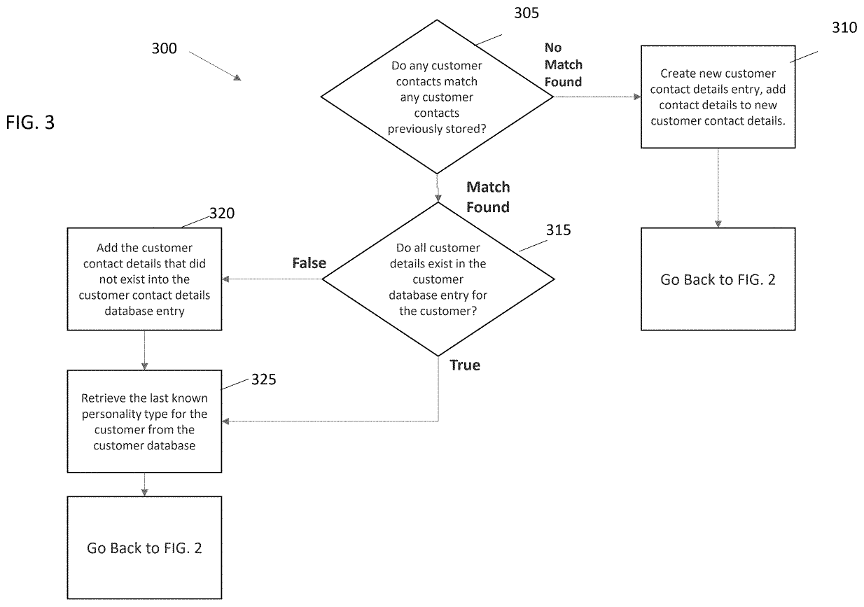

In some embodiments, determining and/or updating the customer contact details is performed as is shown in FIG. 3. Turning to FIG. 3, FIG. 3 shows a method 300 for determining and/or updating customer contact details for personality-based routing for digital contacts, according to some embodiments of the invention.

The method can involve determining if any customer contact details match any customer contacts previously stored (e.g., in the customer database 113 as shown above in FIG. 1) (Step 305). If no matching contact details are found, the method can involve creating a new customer contact details entry, adding digital contact details to the new customer contact details (Step 310), and finishing the routing as shown in FIG. 2. The new customer contact details can have and identifier. The identifier can be a GUID. The identifier can be a customer ID as shown, “Customer_id”: “86457487-e703-4a45-b89f-7c8815d8fblc”.

If matching contact details are found, the method can also involve determining if all customer contact details (e.g., digital contacts and/or analog contacts) exist in the customer database entry for the customer (Step 315). If all customer contact details do not exist in the customer database entry for the customer, then the method can also involve adding the customer contact details that did not exist into the customer contact details customer database entry (Step 320).

The method can also involve retrieving the last known personality type for the customer from the customer database (Step 325), and finishing the routing as shown in FIG. 2.

Turning back to FIG. 2, the method can also involve determining one or more analytics for personality-based routing based on the customer contact details, e.g., as determined and/or updated in FIG. 3.

The method can also involve evaluating (e.g., via the evaluation server 112, as shown above in FIG. 1) digital contacts customer to determine a behavioral profile (Step 235).

The method can also involve evaluating (e.g., via the evaluation server 112, as shown above in FIG. 1) a routing queue that the contact was received on and gathering a list of agents who are online in the particular routing queue (Step 240).

The method can also involve evaluating (e.g., via the evaluation server 112, as shown above in FIG. 1) agent focused data (Step 250). The agent focused data can be a measure of the agents performance in the queue and/or skill measured against desired outcomes across multiple customer personality types.

The method can also involve evaluating the outcomes from Step 235, 240 and 250, to determine a list of agents ordered by priority to service the contact (Step 255). The evaluation can be based on a customer personality type, a personality for the customer in progress for a particular agent, available agents in a queue of the customer, and/or past performance of the agent. The list of agents can be sorted such that the best agent to handle the customer contact is first following the next best, and the next best with the last entry in the list being the worst agent to handle the customer contact.

In some embodiments, the list of agents is saved to a JSON file. The JSON file can appear as shown below in Table 2:

TABLE 2

| | |
|---|---|
| a. | { |
| b. | “Patron_Behavioral_Profile ”: { |
| c. | “profile”: “Original”, |
| d. | |
| e. | } |
| f. | “Agent Rank”: [ |
| g. | { |
| h. | “Rank”: “1”, |
| i. | “Agent ID”: “9590”, |
| j. | }, |
| k. | { |
| l. | “Rank”: “2”, |
| m. | “Agent ID”: “90103”, |
| n. | }, |
| o. | { |
| p. | “Rank”: “3”, |
| q. | “Agent ID”: “9637”, |
| r. | } |
| s. | } |

In some embodiments, the list of agents is sorted from worst to best. In some embodiments, the list of agents can be determined as shown in FIG. 4, discussed in further detail below.

The method can also involve receiving, e.g., via the digital routing engine 115, as shown above in FIG. 1, a prioritized list of agents and a personality type for the contact (Step 260).

The method can also involve, e.g., via the digital routing engine 115, as shown above in FIG. 1, determining if the best agent in the list is routable (Step 265). The determination can be based on whether the agent is available. If the agent is not available, then the method can also involve moving down (or up) in the list to the next best agent (Step 270) and determining if the next best agent is routable (Step 265). The process of Steps 265 to Step 270 can be looped through until the best agent on the list that is routable is found. If the current agent on the list is routable, then the contact is routed to the agent (Step 275). If the list is exhausted and no agent is routable, the contact can go to the next available agent in the queue and/or the next available agent having the skill for the contact.

FIG. 4 shows a method 400 for determining a list of agents ordered by priority to service a contact, according to some embodiments of the invention. The method can involve receiving a list of agents (Step 405). The list of agents can be provided based on the AI routing engine # as shown above in FIG. 1. The AI routing engine # can builds the list by assessing which agents are capable of taking the contact and/or expected ability to handle the contact based on the contact's personality. In some embodiments, the list of agents who can handle any specific contact will only come from agents who are in a particular skill. An agent's skills are determined by what an administrator has configured based on their contact center.

The list of agents can be a previously prioritized list of agents (e.g., as prioritized in Step 255, as described above in FIG. 2). The list of agents can be a random list. The list of agents can be input by an administrator, pulled from a database, or any combination thereof.

The method can involve determining whether the agent is routable (Step 410). Whether the agent is routable can be based on whether the agent is logged in and an up next state. The up next state can be a state that the agent is expected to be in after its current state. An agent can be routable if they are logged in and below a number of maximum contacts. If the agent is routable, then the method can involve using the current list as the agent list (Step 415).

If the agent is not routable, then the method can involve determining if the agent has a contact reserved for routing (Step 420). In some embodiments, one contact can be reserved for an agent who is currently working on their maximum number of customer contacts. When the agent either completes a customer contact and is available to take another contact, the agent's reserve can be checked or if the agent becomes unavailable (e.g., logs out) while the contact is in the reserve before a reserve contact is routed to them, the contact can be placed into a general queue where to be routed to an agent based on age and/or priority.

If the agent has a contact reserved for routing then the agent moves up one rank in the list (Step 425) and the process moves back to Step 410. If the agent does not have a contact reserved for routing, then an expected availability for the agent can be determined (Step 430). The expected availability can be based on an average handle time—longest contact assigned for the agent. For example, agents can be capable of working on one or more than one contact at a time. A stored value can be looked up in a database for an average length of time it can take the current agent and comparing it to the agent's longest contact that they are currently working on. This can determine a time in which we expect the agent to be available to be assigned their next contact to work

The method can involve determining if the service level agreement (SLA) of the contact is less then or equal to the expected availability of the agent (Step 435). If the SLA is greater than the expected availability of the agent, then the agent moves up one rank in the list (Step 425) and the process moves back to Step 410. The SLA can vary based on a point of contact that a customer is communicating over. For example, for a point of contact of a phone call, the SLA can be 5 minutes until the customer is with an agent. In another example, for a point of contact of a chat, the SLA can be 7 minutes until the customer is with an agent. In another example, for a point of contact of a SMS or an email, the SLA can be 25 minutes until the customer is with an agent. In short it is how long the system is targeting to have the contact with an agent. In some embodiments, the list of agents to be matched can be smaller than all agents who can service the contact to, for example, ensure that contacts are not being held from being assigned longer than they would if they were being assigned without a personality match.

If the SLA is less than or equal to the expected availability of the agent, then the method can involve determining whether the agent up next status is available (Step 440). The agent's up next status can be either that they are available when they are finished with their current contact, or will be unavailable when finished with their current contact.

If the agent up next status is not available, then the agent moves up one rank in the list (Step 425) and the process moves back to Step 410. If the agent up next status is available then the method can involve route reserving the current agent (Step 455). In some embodiments, the agent is does not move up or down the list, but the agents are ordered in the list and if the current agent is not available, then the next agent is considered. For example, if agent number 1 is not available, then agent number 2 is tried, and if agent number 2 is not available then agent number 3 is tried, as so forth through the list until agent n, where n is an integer value and the number of agents in the list.

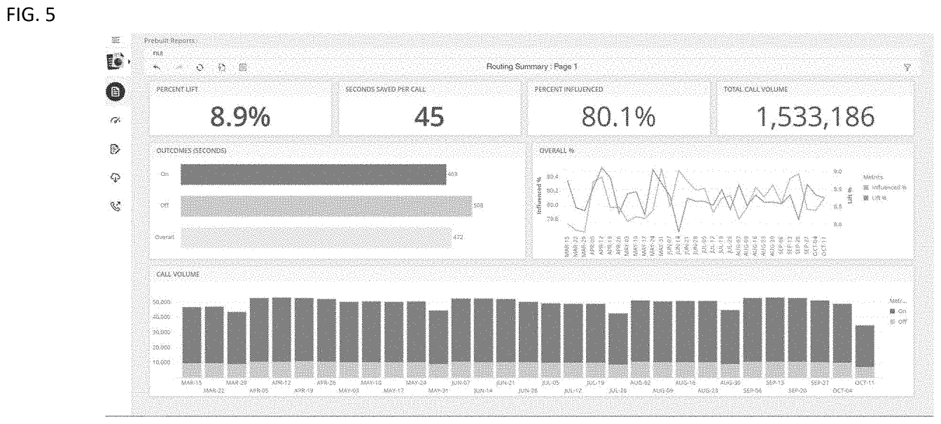

FIG. 5 is a screen shot showing an output screen of analytics of a call center, according to some embodiments of the invention. As shown in FIG. 5, the routing for incoming contacts was able to include 80.1% of contacts, and shortened the average call time by 45 second.

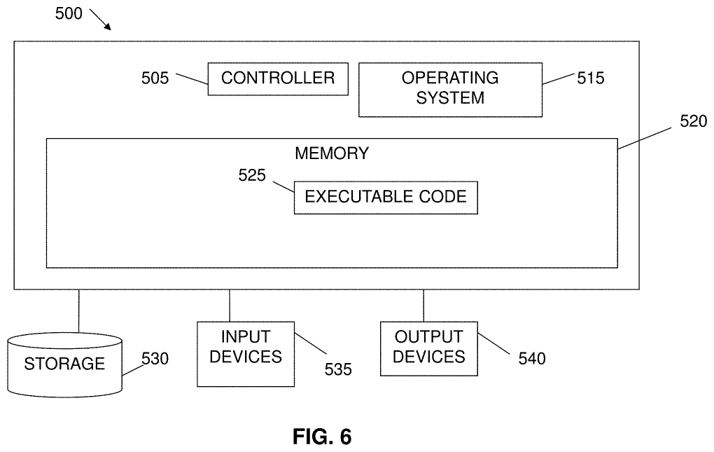

FIG. 6 shows a block diagram of a computing device 500 which can be used with embodiments of the invention. Computing device 500 can include a controller or processor 505 that can be or include, for example, one or more central processing unit processor(s) (CPU), one or more Graphics Processing Unit(s) (GPU or GPGPU), a chip or any suitable computing or computational device, an operating system 515, a memory 520, a storage 530, input devices 535 and output devices 540.

Operating system 515 can be or can include any code segment designed and/or configured to perform tasks involving coordination, scheduling, arbitration, supervising, controlling or otherwise managing operation of computing device 500, for example, scheduling execution of programs. Memory 450 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 can be or can include a plurality of, possibly different memory units. Memory 520 can store for example, instructions to carry out a method (e.g. code 525), and/or data such as user responses, interruptions, etc.

Executable code 525 can be any executable code, e.g., an application, a program, a process, task or script. Executable code 525 can be executed by controller 505 possibly under control of operating system 515. For example, executable code 525 can when executed cause masking of personally identifiable information (PII), according to embodiments of the invention. In some embodiments, more than one computing device 500 or components of device 500 can be used for multiple functions described herein. For the various modules and functions described herein, one or more computing devices 500 or components of computing device 500 can be used. Devices that include components similar or different to those included in computing device 500 can be used, and can be connected to a network and used as a system. One or more processor(s) 505 can be configured to carry out embodiments of the invention by for example executing software or code. Storage 530 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 530 and can be loaded from storage 530 into a memory 520 where it can be processed by controller 505. In some embodiments, some of the components shown in FIG. 6 can be omitted.

Input devices 535 can be or can include for example a mouse, a keyboard, a touch screen or pad or any suitable input device. It will be recognized that any suitable number of input devices can be operatively connected to computing device 500 as shown by block 535. Output devices 540 can include one or more displays, speakers and/or any other suitable output devices. It will be recognized that any suitable number of output devices can be operatively connected to computing device 500 as shown by block 540. Any applicable input/output (I/O) devices can be connected to computing device 500, for example, a wired or wireless network interface card (NIC), a modem, printer or facsimile machine, a universal serial bus (USB) device or external hard drive can be included in input devices 535 and/or output devices 540.

Embodiments of the invention can include one or more article(s) (e.g. memory 520 or storage 530) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A computerized-method for personality based routing for digital contacts, the method comprising:
receiving, via a server, a digital contact from a customer;
retrieving, via the server, customer contact details from a customer database based on the digital contact if the customer contact details exist, wherein the contact details include at least one of phone numbers, emails and social media handles;
creating, via the server, a customer contact details entry to input to the customer database based on the digital contact if the customer contact details does not exist, and adding the digital contact details to the contact details;
determining, via the server, a personality profile based on the customer contact details and one or more machine learned algorithms;
determining, via the server, a prioritized list of available agents from a plurality of agents based on the personality profile; and
routing, via the server, the customer to the agent from the prioritized list of agents having a highest priority.

2. The computerized method of claim 1 further comprising:
determining, via the server, which agents from the prioritized list of agents are currently engaged; and
removing, via the server, the currently engaged agents from the prioritized list of agents.

3. The computerized method of claim 1 wherein the digital contact is a messaging application.

4. The computerized method of claim 1 wherein a number of agents in the plurality of agents is configurable.

5. The computerized method of claim 1 wherein each agent of the plurality of agents includes a past performance indicator for each of one or more personality types.

6. The computerized method of claim 5 wherein determining the prioritized list of available agents further comprises matching the personality profile of the customer with the one or more personality types of the plurality of agents.

7. A non-transitory computer program product comprising instruction which, when the program is executed cause the computer to:
receive a digital contact from a customer;
retrieve customer contact details from a customer database based on the digital contact if the customer contact details exist, wherein the contact details include at least one of phone numbers, emails and social media handles;
create a customer contact details entry to input to the customer database based on the digital contact if the customer contact details does not exist, and adding the digital contact details to the contact details;
determine a personality profile based on the customer contact details and one or more machine learned algorithms;
determine a prioritized list of available agents from a plurality of agents based on the personality profile; and
route the customer to the agent from the prioritized list of agents having a highest priority.

8. The non-transitory computer program product of claim 7 further comprising:
determine which agents from the prioritized list of agents are currently engaged; and
remove the currently engaged agents from the prioritized list of agents.

9. The non-transitory computer program product of claim 7 wherein the digital contact is a messaging application.

10. The non-transitory computer program product of claim 7 wherein a number of agents in the plurality of agents is configurable.

11. The non-transitory computer program product of claim 7 wherein each agent of the plurality of agents includes a past performance indicator for each of one or more personality types.

12. The non-transitory computer program product of claim 11 wherein determining the prioritized list of available agents further comprises matching the personality profile of the customer with the one or more personality types of the plurality of agents.

13. A system for personality based routing for digital contacts, the system comprising:
one or more processors configured to receive a digital contact from a customer;
retrieve customer contact details from a customer database based on the digital contact if the customer contact details exist, wherein the contact details include at least one of phone numbers, emails and social media handles;
create a customer contact details entry to input to the customer database based on the digital contact if the customer contact details does not exist, and adding the digital contact details to the contact details;
determine a personality profile based on the customer contact details and one or more machine learned algorithms;
determine a prioritized list of available agents from a plurality of agents based on the personality profile; and
route the customer to the agent from the prioritized list of agents having a highest priority.

14. The system of claim 13 wherein the one or more processors are further configured to:
determine which agents from the prioritized list of agents are currently engaged; and
remove the currently engaged agents from the prioritized list of agents.

15. The system of claim 13 wherein the digital contact is a messaging application.

16. The system of claim 13 wherein a number of agents in the plurality of agents is configurable.

17. The system of claim 13 wherein each agent of the plurality of agents includes a past performance indicator for each of one or more personality types.

18. The system of claim 17 wherein determining the prioritized list of available agents further comprises matching the personality profile of the customer with the one or more personality types of the plurality of agents.
